(19) United States
(12) Patent Application Publication
(10) Pub. No.: US 2012/0160693 A1
(43) Pub. Date: Jun. 28, 2012

(54) APPARATUS AND METHOD FOR MANUFACTURING BICHROMAL BALLS

(75) Inventors: Yong-Il KWON, Yongin-si (KR); Hwansoo Lee, Seoul (KR); Subong Jang, Anyang-si (KR); Seungjoo Shin, Seoul (KR); Younghoon Kwak, Suwon-si (KR)

(73) Assignee: SAMSUNG ELECTRO-MECHANICS CO., LTD., Suwon (KR)

(21) Appl. No.: 13/324,109

(22) Filed: Dec. 13, 2011

(30) Foreign Application Priority Data
Dec. 23, 2010 (KR) 10-2010-0133600

(51) Int. Cl. B29B 9/00; C25B 7/00

(52) U.S. Cl. 204/647; 425/6; 264/11

(57) ABSTRACT

An apparatus for manufacturing bichromal balls including first and second supply containers; a pair of microchannels for moving the first and second liquids; a pair of nozzles at which the microchannels contact each other; and an actuator, and a method for manufacturing bichromal balls using the same.

### CROSS REFERENCE(S) TO RELATED APPLICATIONS

This application claims the benefit under 35 U.S.C. Section 119 of Korean Patent Application Serial No. 10-2010-0133600, entitled “Apparatus And Method For Manufacturing Bichromal Balls” filed on Dec. 23, 2010, which is hereby incorporated by reference in its entirety into this application.

### BACKGROUND OF THE INVENTION

1. Technical Field

The present invention relates to an apparatus and method for manufacturing bichromal balls used for electronic paper.

2. Description of the Related Art

The first electronic paper is an electrophoretic display called Gyricon developed by the XEROX Co. of the U.S. The Gyricon is known for its structure in which numerous particles called bichromal balls or bichromal beads are filled in a thin, transparent plastic sheet.

A bichromal ball implies a globe formed by fusing two hemispheres of contrasting colors such as white and black. The size of the bichromal ball is 5 to 200 μm in diameter and each hemisphere having a white or a black color is made of a material having a positive charge or a negative charge. Thus the entire bichromal ball has an electric dipole, and a dipole moment in an electric field.

The most basic electrophoretic display uses a method that confines freely rotatable bichromal balls in cavities and shows a black or a white hemisphere by controlling the direction of voltage to display desired information.

An example of a method for manufacturing bichromal balls according to the related art may include a method of using a spinning disk, a method of using a microchannel, a method of using laser ablation, etc.

The method of using a spinning disk and the method of using a microchannel both rely on a method that manufactures bichromal balls by collecting two liquids having different colors in a single stem and inducing capillary instability to decompose the stem into droplets. In this case, ‘capillary instability’ implies a phenomenon that a liquid in a free jet state is decomposed into small droplets by the action of surface tension and perturbations inside and outside the stem.

Manufacturing bichromal balls using the spinning disk method involves injecting the black and white liquids into each of the top and bottom surfaces at the center of the disk that is being rotated at high speed, wherein the liquid flows towards periphery along the top and bottom surfaces of the disk due to the centrifugal force generated by the rotation of the disk. The liquids meet at the edges of the disk to form layers in a single free jet, and the free jet is then decomposed into droplets, such that bichromal balls each configured of a black hemisphere and a white hemisphere are produced.

The spinning disk method may be suited for mass production of bichromal balls, but suffers from a wide distribution of the ball sizes and difficulty in controlling the ball size. The reason for this is that there is no means for directly controlling the decomposition process of the liquid, as the liquid undergoes transitions from a free jet to ligaments, and from ligaments to droplets.

Further, the microchannel based method is a method that produces bichromal balls by inducing capillary instability in a micrometer-sized passage. Since the method of using a microchannel generates a single ball per single microchannel, the distribution of the ball sizes is small. However, the method of using a microchannel relies on an indirect means such as controlling flow rates into the passage for controlling the ball size, and suffers from low productivity.

Since the method of generating bichromal balls via capillary instability such as the above-mentioned methods of using a spinning disk or a microchannel has a limitation in the minimum wavelength of the perturbation necessary to induce instability, it is not suitable for making bichromal balls having sizes less than 100 μm in diameter.

Therefore, in order to make bichromal balls of sizes less than 100 μm, a laser ablation method has been proposed. The method of using laser ablation involves generating bichromal balls by first stacking two raw materials having different colors into a solid bilayer, cutting the bilayer into cylindrically shaped lumps using laser ablation, and finally heat-treating the lumps. However, the laser machining method involves high costs.

### SUMMARY OF THE INVENTION

An object of the present invention is to provide an apparatus for manufacturing bichromal balls that allows easy, accurate, and active control of the size of the bichromal balls.

In addition, another object of the present invention is to provide a method for manufacturing bichromal balls having controlled size and a narrow distribution of ball sizes.

Another object of the present invention is to provide bichromal balls for an electronic paper manufactured by the above-mentioned apparatus and method.

According to an exemplary embodiment of the present invention, there is provided an apparatus for manufacturing bichromal balls, including: first and second liquid supply containers; a pair of microchannels for moving the first and second liquids; a pair of nozzles at which the microchannels contact each other; and an actuator.

The actuator may be provided in any one of the outside and inside of the pair of microchannels.

The actuator may be configured in a part or all of the microchannel.

The actuator may be a piezoelectric material.

The piezoelectric material may be at least one selected from a group consisting of lead zirconate titanate (PZT, Pb[ZrₓTi₁₋ₓ]O₃ 0<x<1), PbTiO₃, LiNbO₃, ZnO, quartz, rochelle salt (potassium sodium tartrate, NaKC₄H₄O₆), barium titanate, and PVDF.

The actuator may be a heating element.

Each nozzle at which the microchannels contact each other may be disposed to be close to each other as maximally as possible.

According to an exemplary embodiment of the present invention, there are provided bichromal balls that are 100 μm or less in diameter.

The bichromal balls may be comprised of two different colors including black and white, and may be suitable for both black and white and color e-paper.

According to another exemplary embodiment of the present invention, there is provided a method for manufacturing bichromal balls, including: passing two kinds of liquids having different colors through microchannels and supplying the liquids; controlling the pressure of the liquids in the microchannels; and forming bichromal balls as the two kinds of liquids pass through the nozzles.

Control of liquid pressure in the microchannel may be performed by a method of attaching a piezoelectric material to the microchannel and applying voltage to the piezoelectric material.

Control of liquid pressure in the microchannel may be performed by a method of attaching a heating element to the microchannel to form bubbles.

The space outside the nozzles where the bichromal balls are generated may be filled with a third fluid.

### BRIEF DESCRIPTION OF THE DRAWINGS

FIG. 1 is a diagram showing a structure of an apparatus for manufacturing bichromal balls according to the exemplary embodiment of the present invention;

FIGS. 2 and 3 are diagrams showing a process of driving an actuator according to the exemplary embodiment of the present invention;

FIG. 4 is a diagram showing an electrical circuit of the actuator according to the exemplary embodiment of the present invention; and

FIG. 5 is a diagram showing computer simulation results of the process of manufacturing bichromal balls according to the exemplary embodiment of the present invention.

### DESCRIPTION OF THE PREFERRED EMBODIMENTS

Hereinafter, exemplary embodiments will be described in detail with reference to the accompanying drawings.

The terms used in the specification are used to describe only specific embodiments and are not intended to limit the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

In addition, a thickness or a size of each layer will be exaggerated for convenience of explanation or clarity and like reference numbers will indicate the same components, in the drawings below. As used in the present specification, a term “and/or” includes any one or at least one combination of enumerated items.

Exemplary embodiments of the present invention relate to an apparatus and method for manufacturing bichromal balls having a controlled size and a narrow distribution of sizes by actively controlling the generation of the bichromal balls.

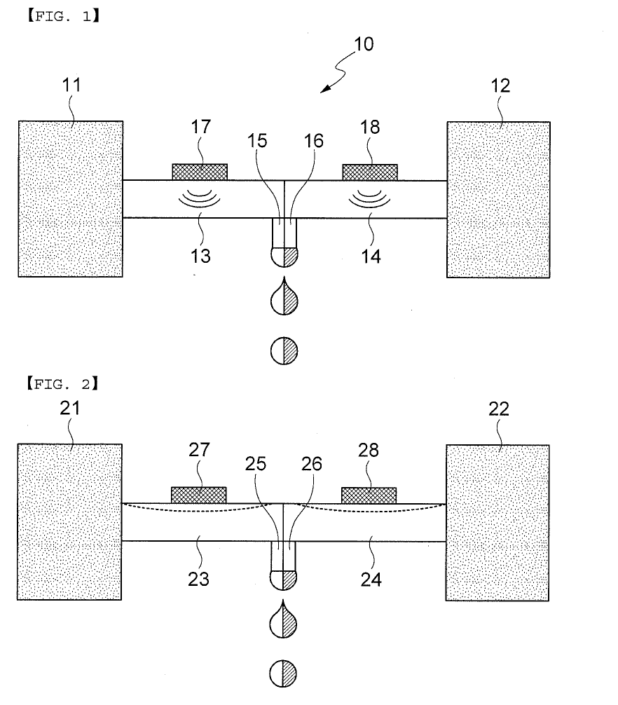

An apparatus 10 for manufacturing bichromal balls according to the exemplary embodiment of the present invention is shown in FIG. 1. Referring to FIG. 1, the apparatus 10 for manufacturing bichromal balls is configured to include a pair of supply containers 11 and 12 for supplying a first liquid and a second liquid having different colors for manufacturing bichromal balls having different colors, a pair of microchannels 13, 14 for moving the first liquid and the second liquid, a pair of nozzles 15 and 16 at which the microchannels contact each other; and actuators 17 and 18.

Existing methods produce bichromal balls by inducing capillary instability that decomposes a free jet of liquid into small droplets. In this case, the final size and size distribution of the bichromal balls is very dependent on capillary instability.

Therefore, the exemplary embodiment of the present invention can control the size and size distribution of the bichromal balls to a desired level by an active method that attaches a separate actuator to any one of the outside and inside of a pair of microchannels.

The actuator according to the exemplary embodiment of the present invention may be formed on a portion or all of the microchannels. A detailed example of the actuator may be a piezoelectric material or a heating element.

In the exemplary embodiment of the present invention, when the actuator is the piezoelectric material, the piezoelectric material is attached to the pair of microchannels. Next, the actuator is driven by applying voltage to the piezoelectric material. When the voltage is applied to the piezoelectric material, the piezoelectric material is deformed and the wall surface of the microchannel contacting the piezoelectric material is also deformed. When the wall surface of the microchannel is bent inwardly, the liquid pressure in the microchannel is increased.

On the other hand, when the wall surface of the microchannel is bent outwardly, the liquid pressure in the microchannel is reduced. The warpage displacement of the wall surface of the microchannel and the pressure of the liquid in the microchannel are controlled by controlling the magnitude in voltage applied to the piezoelectric material. Therefore, the first liquid and the second liquid passing through the microchannel contact each other at the nozzles, thereby making it possible to control the size of the discharged droplet.

When the actuator according to the exemplary embodiment of the present invention is a piezoelectric material, the piezoelectric material may be at least one selected from a group consisting of lead zirconate titanate (PZT, Pb[ZrₓTi₁₋ₓ]O₃ 0<x<1), PbTiO₃, LiNbO₃, ZnO, quartz, rochelle salt (potassium sodium tartrate, NaKC₄H₄O₆), barium titanate, and PVDF.

That is, the exemplary embodiment of the present invention uses a piezoelectric effect which converts electrical energy to mechanical energy through the piezoelectric material to actively control the size of the bichromal balls. In other words, when pressure or vibrations (mechanical energy) are applied to the piezoelectric material, electricity is generated, and vibrations are generated by applying electricity thereto, such that the conversion is made.

According to the exemplary embodiment of the present invention, when the actuator is the piezoelectric material and is driven by applying voltage to the piezoelectric material, the microchannel is contracted in the case where the voltage is a positive voltage and the microchannel is expanded in the case where the voltage is a negative voltage.

That is, as shown in FIG. 2, the piezoelectric material as the actuators 27 and 28 according to the exemplary embodiment of the present invention is attached to the outside of the microchannels 23 and 24 and when the positive voltage is applied to the actuators 27 and 28, the wall surface of the microchannel contacting the piezoelectric material is bent downwardly, that is, in a direction to which the droplet is discharged (dotted portion). That is, the microchannels 23 and 24 are deformed by the voltage applied to the actuators 27 and 28 and the first liquid and the second liquid are discharged by the positive liquid pressure generated in the microchannel due to the deformation.

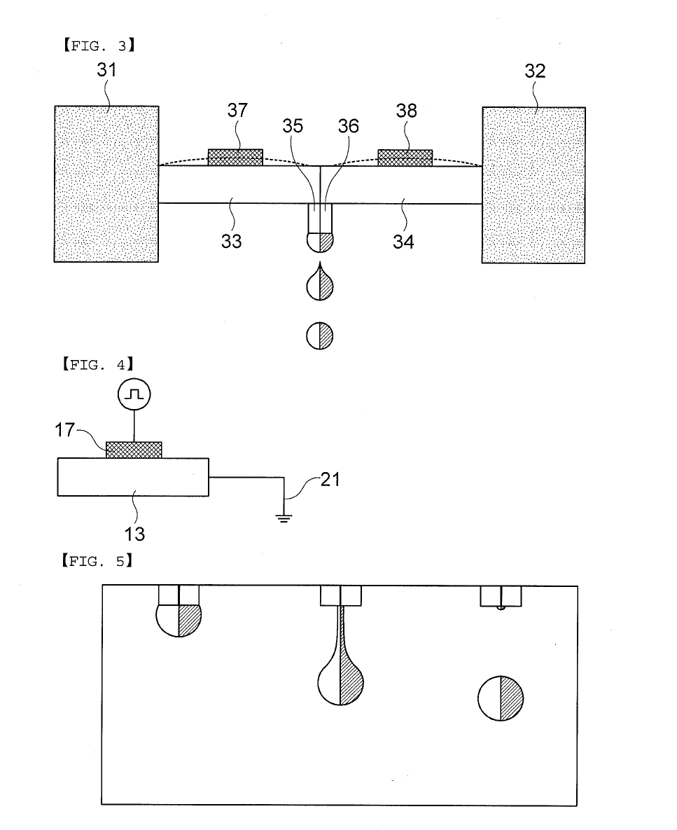

In addition, as shown in FIG. 3, the piezoelectric material is returned to an original shape by attaching the piezoelectric material as actuators 37 and 38 according to the exemplary embodiment of the present invention to the outside of the microchannels 33 and 34 and again lowering the voltage applied to the actuators 37 and 38.

In addition, when a negative voltage is applied by further lowering the voltage applied to the piezoelectric material, the wall surface of the microchannel contacting the piezoelectric material is bent upwardly. In this case, a negative liquid pressure is generated in the microchannels 33 and 34 to stop the discharge of liquid. Finally, the liquid is cut and a droplet is generated, by the action of surface tension.

In the exemplary embodiment of the present invention, when the piezoelectric material as the actuator is attached to the microchannel, the voltage may be applied to the piezoelectric material by an electrical connection with the microchannel in order to drive the piezoelectric material. The electrical circuit is shown in FIG. 4.

In addition, when the piezoelectric material is used as the actuator, another method for controlling the size of the finally discharged droplet by deforming the microchannel in the vicinity of the nozzle discharging the first liquid and the second liquid by attaching the piezoelectric material in the vicinity of the nozzle may be used, in addition to the method of deforming the microchannel by applying voltage.

Therefore, the attachment position of the actuator according to the exemplary embodiment of the present invention may be a portion or all of the pairs of microchannels and may be appropriately controlled according to the driving principle. In addition, in the accompanying drawings, the shape of the actuator is shown in a quadrangular shape, but the shape is not limited when the actuator has the identical effects according to the exemplary embodiment of the present invention.

In addition, according to another exemplary embodiment of the present invention, the actuator may be a heating element. This is to generate bubbles in the microchannel by instantly volatizing the first and second liquids using the heating element. Therefore, the pressure in the microchannel is increased due to formation of bubbles and the generation of the droplet of the first and second liquids can be controlled.

The heating element according to the exemplary embodiment is not specifically limited and when the heating element is a heating unit, it is not specifically limited. In addition, the heating element is positioned in the microchannel and may be attached to a portion or all of the microchannel. The shape or position is not specifically limited.

Each nozzle at which the microchannels contact each other may be positioned to be close to each other as maximally as possible. In order to manufacture identical particles made of halves of different colors by contacting the first liquid with the second liquid, each nozzle at which the microchannels contact each other may be positioned to be close to each other as maximally as possible. Therefore, the droplets discharged from each nozzle are immediately coupled and form bichromal balls comprised of hemispheres of different colors.

The bichromal balls manufactured by using the apparatus according to the exemplary embodiment of the present invention are 100 μm or less in diameter, and preferably, about 30 μm in diameter. This can show remarkable effects discriminated from the related art when considering the limitation of the high-speed rotation, the difficulty in size control caused from using a passive method that is dependent on capillary instability and thus difficult to maintain the manufacturing process under predetermined conditions, and the difficulty in manufacturing bichromal balls with diameters of 100 μm or less

The bichromal balls according to the exemplary embodiment of the present invention may be formed of the hemispheres each having black and white colors or other two different colors. That is, various colors may be implemented, including black and white.

To this end, the particles for implementing black and white and the kind of pigments for implementing various colors are not specifically limited. Generally, various black and white particles and color pigments used to manufacture the electronic paper may be used.

Hereinafter, the method for manufacturing bichromal balls according to the exemplary embodiment of the present invention will be described in detail.

The method for manufacturing bichromal balls may include passing two different kinds of liquids through the microchannel and supplying them, controlling the pressure of liquid in the microchannel, and forming the bichromal balls by passing the two kinds of liquids through the nozzle.

In detail, two liquids having different colors that are a raw material of the bichromal balls are provided from the pair of supply containers and are supplied through each microchannel. When each liquid passes through the microchannel, voltage is applied to a piezoelectric material attached to the microchannel or the pressure in the microchannel is controlled using a heating element, or the like.

For example, when a positive voltage is applied to the piezoelectric material disposed at the outer wall of the microchannel, the piezoelectric material is deformed by being bent into the microchannel. Therefore, the outer wall of the microchannel is bent and a positive pressure is generated in the microchannel, thereby starting the discharge of liquid.

In addition, when voltage is reduced, the deformed piezoelectric material disposed on the outer wall of the microchannel is returned to its original state and when a negative voltage is applied to the piezoelectric material, the outer wall of the microchannel is deformed by being bent into the piezoelectric material. In this case, a negative pressure is generated in the microchannel to stop the discharge of liquid. Finally, break-up of liquid and generation of droplet follow due to surface tension.

In addition, the pair of nozzles is disposed at a sufficiently close distance to each other and simultaneously discharges liquid. Therefore, the liquid discharged from each nozzle is immediately coupled and forms bichromal balls comprised of hemispheres of different colors.

The space outside the nozzles where the bichromal balls are generated may be filled with a third fluid such as water. The third fluid serves to form the balls as a more complete sphere by increasing the surface tension of liquid forming the balls. Finally, solid bichromal balls are obtained after being subjected to an ultraviolet curing process, etc.

In addition, the exemplary embodiment of the present invention manufactures the apparatus configured to include a plurality of microchannels, nozzles, and actuators by using a microfabrication method, thereby making it possible to mass-produce the bichromal balls.

FIG. 5 shows computer simulation results under the same conditions as the process of manufacturing bichromal balls according to the exemplary embodiment of the present invention. It can be appreciated that a bichromal ball formed of hemispheres of different colors by coupling droplets discharged from a pair of nozzles.

When the manufacturing apparatus according to the exemplary embodiment of the present invention is used, it can easily and accurately control the ball size and reduce the manufacturing costs, as compared with the related art.

As set forth, the exemplary embodiment of the present invention uses the apparatus for manufacturing bichromal balls to easily and accurately control the size and size distribution of the bichromal balls, thereby making it possible to manufacture bichromal balls of desired size.

In addition, the method for manufacturing bichromal balls according to the exemplary embodiment of the present invention adds a separate actuator to actively control the size and size distribution of the bichromal balls, thereby making it possible to manufacture bichromal balls of fine sizes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An apparatus for manufacturing bichromal balls, comprising:
first and second liquid supply containers;
a pair of microchannels for moving the first and second liquids;
a pair of nozzles at which the microchannels contact each other; and
an actuator.

2. The apparatus for manufacturing bichromal balls according to claim 1, wherein the actuator is provided in any one of the outside and inside of the pair of microchannels.

3. The apparatus for manufacturing bichromal balls according to claim 1, wherein the actuator is configured in a part or all of the microchannel.

4. The apparatus for manufacturing bichromal balls according to claim 1, wherein the actuator is a piezoelectric material.

5. The apparatus for manufacturing bichromal balls according to claim 4, wherein the piezoelectric material is at least one selected from a group consisting of lead zirconate titanate (PZT) (Pb[ZrₓTi₁₋ₓ]O₃ 0<x<1), PbTiO₃, LiNbO₃, ZnO, quartz, rochelle salt (potassium sodium tartrate, NaKC₄H₄O₆), barium titanate, and PVDF.

6. The apparatus for manufacturing bichromal balls according to claim 4, wherein the piezoelectric material is formed at a position adjacent to the nozzle.

7. The apparatus for manufacturing bichromal balls according to claim 1, wherein the actuator is a heating element.

8. The apparatus for manufacturing bichromal balls according to claim 1, wherein each nozzle at which the microchannels contact each other is disposed to be closed to each other as maximally as possible.

9. Bichromal balls with diameters of 100 μm or less manufactured using the apparatus for manufacturing bichromal balls according to claim 1.

10. The bichromal balls according to claim 9, wherein the bichromal balls have two different colors including black and white.

11. A method for manufacturing bichromal balls, comprising:
passing two kinds of liquids having different colors through microchannels and supplying the liquids;
controlling the pressure of the liquids in the microchannels; and
forming bichromal balls as the two kinds of liquids pass through the nozzles.

12. The method for manufacturing bichromal balls according to claim 11, wherein control of liquid pressure in the microchannel is performed by a method of attaching a piezoelectric material to the microchannel and applying voltage to the piezoelectric material.

13. The method for manufacturing bichromal balls according to claim 11, wherein control of liquid pressure in the microchannel is performed by a method of attaching a heating element to the microchannel to form bubbles.

14. The method for manufacturing bichromal balls according to claim 11, wherein the space outside the nozzles where the bichromal balls are generated is filled with a third fluid.
